(19) United States
(12) Patent Application Publication
(10) Pub. No.: US 2023/0184990 A1
(43) Pub. Date: Jun. 15, 2023

(54) SOURCE PORT SYSTEM AND METHOD FOR GAMMA RAY SCANNER TOOL

(71) Applicant: Baker Hughes Oilfield Operations LLC, Houston, TX (US)

(72) Inventors: Feyzi Inanc, Houston, TX (US); Allan Jones, Houston, TX (US); Peng Yuan, Houston, TX (US); Toyli Anniyev, Houston, TX (US); Marc Ramirez, Houston, TX (US)

(73) Assignee: Baker Hughes Oilfield Operations LLC, Houston, TX (US)

(21) Appl. No.: 18/077,808

(22) Filed: Dec. 8, 2022

Related U.S. Application Data
(60) Provisional application No. 63/287,829, filed on Dec. 9, 2021.

(51) Int. Cl. G01V 5/12

(52) U.S. Cl. CPC G01V 5/12

(57) ABSTRACT

A downhole logging system includes a gamma ray source positioned within a logging tool. The system further includes a collimator associated with the gamma ray source, the collimator having an opening to direct a flow of radiation into the formation. The system also includes a radiation detector operable to detect backscatter radiation from the area. The system further includes a motor to rotate the collimator in either a continuous or stepping fashion for scanning a borehole and an actuator associated with the gamma ray source. The actuator moves the gamma ray source between a first position and a second position, the first position being misaligned with the opening and the second position being aligned with the opening.

### CROSS-REFERENCE TO RELATED APPLICATIONS

This application claims priority to and the benefit of U.S. Provisional Pat. Application No. 63/287,829, filed Dec. 9, 2021, titled “SOURCE PORT SYSTEM AND METHOD FOR GAMMA RAY SCANNER TOOL,” the full disclosure of which is hereby incorporated by reference in its entirety for all purposes.

### BACKGROUND

### 1. Field of Disclosure

This disclosure relates in general to oil and gas tools, and in particular, to systems and methods for downhole inspection operations.

### 2. Description of the Prior Art

Downhole logging and inspection tools are used to collect various data about a wellbore or well system. For example, gamma ray logging tools may be used to detect wellbore properties, such as formation density, among others, while downhole inspection tools may be used to detect errors or flaws in associated downhole components. Some gamma ray instruments send gamma rays into a formation and detect those that are scattered back. Energy levels of the backscattered radiation may be utilized to determine one or more properties. Typically, a source is collimated so that the gamma rays are sent in a certain direction. However, prior to installation into the wellbore, it may be difficult to sufficiently shield the source, especially near openings associated with the collimator.

### SUMMARY

Applicant recognized the problems noted above herein and conceived and developed embodiments of systems and methods, according to the present disclosure, for downhole inspection tools.

In an embodiment, a downhole logging system includes a gamma ray source positioned within a logging tool, the gamma ray source to emit radiation into an area surrounding the logging tool. The downhole logging tool also includes a collimator associated with the gamma ray source, the collimator to adjust an opening to direct a flow of radiation into the formation to permit gamma ray scanning of the formation. The downhole logging tool further includes a radiation detector operable to detect backscatter radiation from the area, the radiation detector associated with an aperture movable to be aligned with the collimator associated with the source. The downhole logging tool also includes a motor to rotate the collimator and the aperture in either a continuous or stepping fashion for scanning a borehole. The downhole logging tool includes an actuator associated with the gamma ray source, the actuator moving the gamma ray source between a first position and a second position, the first position being misaligned with the opening and the second position being aligned with the opening.

In an embodiment, a downhole logging tool includes a housing, the housing having an aperture to permit emission of radioactive materials from the housing. The downhole logging tool also includes a source package and a source receptacle. The source package includes a gamma ray source and a source package shielding material. The source receptacle includes a first shielding material, the first shielding material being movable from a first position blocking the aperture and a second position misaligned with the aperture. The source receptacle also includes a low density attenuating material, positioned to at least partially surround the gamma ray source, the low density attenuating material being movable from a first position misaligned with the aperture and a second position aligned with the aperture. The downhole logging tool further includes an actuator, the actuator coupled to the source package, wherein the actuator applies a force to the source package to drive movement between the first position to the second position.

In an embodiment, a method includes providing a downhole logging tool having a source in a first position, the first position arranging the source out of alignment with an aperture. The method also includes positioning the downhole logging tool within a wellbore. The method further includes causing the source to move to a second position, different from the first position, the second position arranging the source in alignment with the aperture. The method includes performing one or more logging operations. The method also includes causing the source to move back to the first position. The method further includes retrieving the downhole logging tool from the wellbore.

In an embodiment, a downhole logging system includes a gamma ray source positioned within a logging tool, the gamma ray source to emit radiation into an area surrounding the logging tool. The downhole logging system also includes a collimator associated with the gamma ray source, the collimator having an opening to direct a flow of radiation into the formation to permit gamma ray scanning of the formation. The downhole logging system further includes a radiation detector operable to detect backscatter radiation from the area. The downhole logging system also includes a motor to rotate the collimator in either a continuous or stepping fashion for scanning a borehole. The downhole logging system further includes an actuator associated with the gamma ray source, the actuator moving the gamma ray source between a first position and a second position, the first position being misaligned with the opening and the second position being aligned with the opening.

### BRIEF DESCRIPTION OF THE DRAWINGS

The present technology will be better understood on reading the following detailed description of non-limiting embodiments thereof, and on examining the accompanying drawings, in which:

FIG. 1 is a schematic cross-sectional view of an embodiment of a downhole logging tool positioned in a wellbore, in accordance with various embodiments;

FIG. 2A is a graphical representation of an example of a dose field, in accordance with various embodiments;

FIG. 2B is a schematic diagram of an embodiment of a logging tool, in accordance with various embodiments;

FIGS. 3A and 3B are schematic diagrams of embodiments of a logging tool, in accordance with various embodiments;

FIG. 4A is a side view of an embodiment of a removable shield, in accordance with various embodiments;

FIG. 4B is a top view of an embodiment of a removable shield, in accordance with various embodiments;

FIG. 4C is a top view of an embodiment of a removable shield, in accordance with various embodiments;

FIG. 4D is a top view of an embodiment of a removable shield, in accordance with various embodiments;

FIG. 4E is a graphical representation of an example of exposure rates, in accordance with various embodiments; and

FIG. 5 is a flow chart of an embodiment of a method for obtaining a wellbore measurement, in accordance with various embodiments.

### DETAILED DESCRIPTION

The foregoing aspects, features and advantages of the present technology will be further appreciated when considered with reference to the following description of embodiments and accompanying drawings, wherein like reference numerals represent like elements. In describing the embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present disclosure are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations. Moreover, the use of “approximately” or “substantially” or the like may refer to +/-10% of a given value or range.

Embodiments of the present disclosure are directed toward systems and methods for shielding a downhole inspection tool, such as a nuclear inspection tool. In at least one embodiment, the downhole inspection tool is a gamma ray scanner that is used to scan a borehole azimuthally. Embodiments may also be implemented with other types of nuclear inspection tools, such as those that use neurons or x-rays, among other options, and accordingly are not limited to only gamma ray tools. Various embodiments may utilize tools for plug and abandonment operations, but it should be appreciated that the present disclosure is not limited to such operations and can be used for a variety of different inspection operations. Furthermore, systems and methods may be used with a variety of different radioactive interrogation techniques, but various embodiments may be described with respect to gamma ray sources for convenience. Additionally, while embodiments may describe operations associated with oil and gas operations, systems and methods may be deployed in a variety of different industries.

By way of example with a wellbore, such as a cased wellbore, a wellbore inspection tool may be sourced up (e.g., a source is installed within the tool) and kept in a lubricator or other component prior to installation within the wellbore. However, such a configuration may position the tool in an area where personnel would normally be operating, but due to the presence of the source, would be positioned a distance away in order to comply with various health, safety, and environmental (HSE) requirements. Such an arrangement may delay or slow operations at the wellbore. Various embodiments of the present disclosure may overcome this delay by using a movement device, such as a piston, to translate the source from a first position to a second position, where a first position is a shielded position and a second position is a position where the source is aligned with an opening associated with a collimator. The second position may be referred to as an un-shielded or partially un-shielded position in that the source may include shielding along one or more sides but not along other areas. In the first position, there is no or substantially no direct communication between the source and the collimator, and as a result, no beam would be exiting the tool. While in the first position, the source may be blocked from the collimator by one or more masses or components, for example, along an axis of the tool. Additionally, the blockage may be rotationally positioned between the source and the opening associated with the collimator. However, when the cartridge is moved to the second position, which may be accomplished using a remotely operated actuator, the source is then moved into direct communication and/or at least partially direct with the collimator to interrogate the formation. Such a configuration reduces HSE concerns and brings exposure limits to within or below present guidelines.

A typical gamma-gamma nuclear logging tool (e.g., tool, inspection tool, gamma tool, etc.) is usually a relatively small diameter tool, which does not leave much space for shielding material to reduce a dose field around the tool. As a result, the dose field around the tool within a threshold distance may exceed HSE requirements, which may lead to areas of the platform or rig to be cordoned off or otherwise access restricted. Another feature with those tools is the shielding material is not uniform around the source, causing the dose field around the tool to vary significantly as a function of the azimuth. In addition, various tools include a source port collimator meant to send a beam of radiation (e.g., gamma rays, neutrons, etc.) into the formation. The existence of the port increases the dose field in the collimator direction significantly and can be well above any acceptable limits, further creating a barrier or restricted area and hindering operations. Applicant has recognized such problems associated with the source port design for HSE concerns.

Embodiments may be directed toward a gamma scanner design (or various other nuclear interrogation tools) to be used for plug and abandonment logs, among other operations, and to scan the completion azimuthally. One factor in such an implementation is the gamma beam stability as a function of the azimuth. The design used in conventional density tools makes that challenging or unfeasible. Various embodiments overcome the drawbacks of existing designs by positioning a source cartridge (e.g., source) to be aligned with a z-axis of the tool. Furthermore, embodiments are directed toward addressing HSE concerns by providing a uniform dose field around the tool, removing the dose field induced by the nuclear particles (e.g., gamma rays) traveling through the source collimator, and reducing an overall dose field around the tool with one or more clamps or portable shields. In at least one embodiment, the overall dose field may be reduced to approximately 2 mR/hr level approximately 4 feet (approximately 1.2 meters) from the tool. Problems with existing tools may be overcome using systems and methods of the present disclosure that include a configuration where the source is inserted into the tool to align with the z-axis through a sonde housing. Additionally, a lower sub may be mounted into the sonde housing to enclose the source port.

HSE concerns are addressed by, among various options, a piston like source cartridge movement between a shielded position and a position where the source cartridge is aligned with the collimator. In at least one embodiment, the movement is driven by a linear actuator behind the cartridge, but it should be appreciated that a variety of mechanisms may be deployed to move the cartridge between the locations. Moreover, the movement may not be linear. When the cartridge is inserted, a receptacle, that may be formed in one or more masses or shields, blocks the collimator due to the position of the cartridge. Accordingly, an opening associated with the collimator is blocked from gamma rays (or other particles) so that these particles do not exit through the collimator. In at least one embodiment, a spring may hold the cartridge in a first position when the tool is not in use on the surface. When the tool is lowered into the borehole, the actuator is powered up and it pushes (or otherwise moves) the cartridge into the second position. In the second position, there is a direct or substantially direct communication between the source and the collimator to enable a gamma ray beam to illuminate the formation. The cartridge may then be pulled back before the tool comes out of the borehole.

Furthermore, HSE concerns may also be addressed through the implementation of a clamp on shield around the tool and/or around the lubricator or other components at the site. In at least one embodiment, the shield has a uniform thickness and may surround the tool. In other embodiments, the shield has a variety thickness based, at least in part, on a tool or component configuration. Various embodiments may include hinges or clamps that enable rapid installation and removal of the shield. Furthermore, the tool may include one or more positioning or locating devices to maintain its position on the tool. In various embodiments, the clamp is installed prior to moving the source from the first location to the second location. In other embodiments, the clamp is installed on the lubricator or other component prior to moving the tool itself and/or the source. As the tool is prepared for installation, the clamp may be driven upwards along the tool body and/or the clamp may be stationary as the tool is driven downward along the clamp and into the wellbore. In various embodiments, the clamp may be remotely removed or removed from a distance using one or more tools.

Systems and methods of the present disclosure may be directed toward a downhole tool that includes one or more motion devices to drive movement of a source cartridge between a first position and a second position. In at least one embodiment, the motion device is a linear actuator, such as but not limited to, a mechanical actuator (e.g., screw, wheel and axle, cam, etc.), a hydraulic actuator, a pneumatic actuator, an electro-mechanical actuator, and the like. Furthermore, embodiments may use rotary actuators or any type of mover that allows transition of the source between at least a first position and a second position. In at least one embodiment, such a mover may enable operations where the source is not aligned with a collimator at an uphole location or prior to use, is moved into position when downhole, and is then moved back into the first position prior to retrieval. Various embodiments may further provide positions with fail safe or normally-closed configurations where failure of one or more components, such as a component of the mover, will move the source into the first position where the source is shielded from the opening.

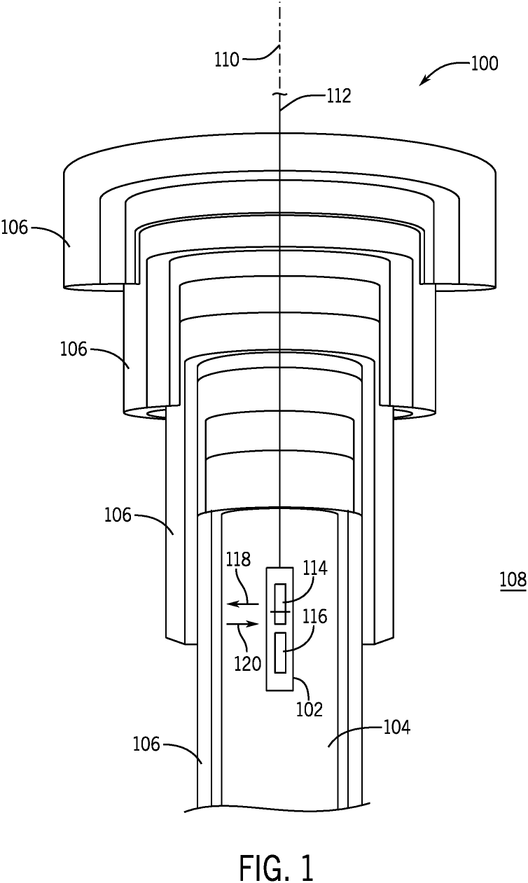

FIG. 1 is a partial cross-sectional view of a well system 100 in which a downhole logging tool 102 is positioned to measure one or more characteristics of the well system 100 and/or associated components, in accordance with one or more embodiments. The illustrated well system 100 includes a multi-barrier well 104 with a plurality of barriers 106, such as tubing, cement layers, casing, and the like. The well 104 may be any type of well, including but not limited to conventional and unconventional hydrocarbon producing wells. Moreover, the well 104 may include deviated or angled sections. The logging tool 102 may be deployed downhole into the well 104 to perform various logging functions, such as detection of various anomalies, such as well defects, eccentricity, flaw structure, topology, integrity, and other information. Additionally, in various embodiments, the logging tool 102 may be deployed to obtain information indicative of wellbore and/or formation characteristics, such as formation density. In various embodiments, the logging tool 102 may include an imaging device such as a nuclear imaging device, or various other types of logging devices such as acoustic devices, electromagnetic devices, magnetic resonance devices, other forms of radiation-based devices, among others. It should be appreciated that the logging tool 102 may be deployed through one or more tubulars arranged within an annulus of the wellbore.

In the illustrated embodiment, the well system 100 includes a series of tubular barriers 106, which may include metallic casing or tubing and cement walls between the casing. Specifically, in various embodiments, the wellbore may be cased by the tubular casings and held into place against the formation 108 and/or other casing sections via cement forming the cement walls. It may be desirable to inspect various characteristics of the casing and/or the cement walls, for example for potential abnormalities or defects such as fluid channel defects, bonding defects, air voids, defects in the casing, annulus defects, cement bonding defects, and eccentricity of the well, among others. Moreover, certain logging methods may be difficult to perform through the barriers 106. Abnormalities or defects may be referred to as wellbore characteristics and may further include additional information such as formation properties and the like.

Moreover, as noted above, logging tools may be useful in determining one or more characteristics of the formation. However, in multi-barrier wells, logging tools may need sufficient strength and/or intensity in order to penetrate into the formation 108 through the barriers 106. Furthermore, obtaining information from the barriers 106 may also utilize similar strength tools. One such tool composition is a nuclear logging tool, such as a gamma ray instrument. The gamma ray instrument includes at least one source and at least one detector. The source emits gamma rays into the formation and the detector receives backscattered radiation. The gamma ray instrument enables a variety of different measurements, such as formation density. Furthermore, it should be appreciated that various other nuclear logging tools may be utilized that include different sources, such as neutrons.

In the illustrated embodiment, the logging tool 102 traverses into the well 104 along a well axis 110 and is supported by a wireline 112, which may be a cable reinforced for wellbore operations and further including conductive materials to transfer energy and data signals. It should be appreciated that while a wireline system is illustrated in FIG. 1, embodiments of the present disclosure may be disposed on rigid tubing, coiled tubing, and with various other wellbore tubing structures. Furthermore, as noted above, the wireline 112 may be tripped down through a tubing arranged within an annulus.

It should be appreciated that various embodiments discussed herein describe logging tool 102 as a gamma radiation imaging tool, which may include a radiation generation unit 114 and a radiation detection unit 116. The radiation generation unit 114 may emit radiation 118 toward the formation 112 and possibly through one or more barriers, which may interact with one or more targets or regions of interest and produce a backscatter stream 120 of radiation toward the radiation detection unit 116. In various embodiments, the radiation generation unit 114 is a gamma ray emitter (e.g., Cesium-137). The radiation generation unit 114 may include a source that emits gamma rays isotropically and then is collimated to direct those gamma rays in a particular direction. Due to the stochastic nature of radiation emission, the source used for the radiation generation unit 114 may continuously emit gamma rays, which may be shielded or blocked until it is desired to emit the gamma rays into the formation. It should be appreciated that other sources may also be used, such as cyclic particle accelerators, inverse geometry x-ray machines (such as the configuration shown in U.S. Pat. Application No. 16/517,089, now U.S. Pat. No. 11,073,627, which is hereby incorporated by reference), and the like.

In previous gamma ray instruments, the source of the radiation generation unit 114 and the radiation detection unit 116 may be collimated, which as noted herein, may refer to a shielded body that includes one or more openings through which to direct emitted particles and/or energy. As a result, emission of the gamma rays is known in a particular direction, and subsequent detection comes from a particular direction. In at least one embodiment, a “gamma scanner” may be utilized for multi-string evaluation. Gamma scanners may refer to one or more tools, which may include a detector and/or a source, that include shields or collimators that are aligned and synchronically rotated. By way of example, a collimator may surround the source and be moved to different azimuthal positions. In one or more embodiments, a collimator may surround the detector and be moved to different azimuthal positions to adjust a position of an aperture. In one or more embodiments, both the detector and source are collimated. During operation, rotation of a source collimator and/or a detector aperture may be utilized to acquire azimuthal information. By way of example only, tools such as those described in U.S. Pat. Application No. 16/727,109 (now U.S. Pat. No. 11,067,716) and U.S. Pat. Application No. 16/590,796 (now U.S. Pat. No. 11,066,926), the disclosures of which are hereby incorporated by reference, may be utilized as gamma scanners.

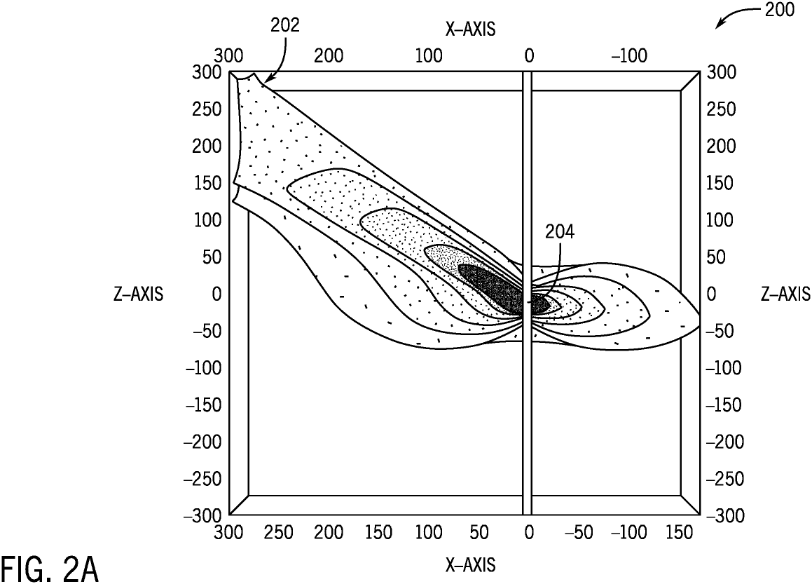

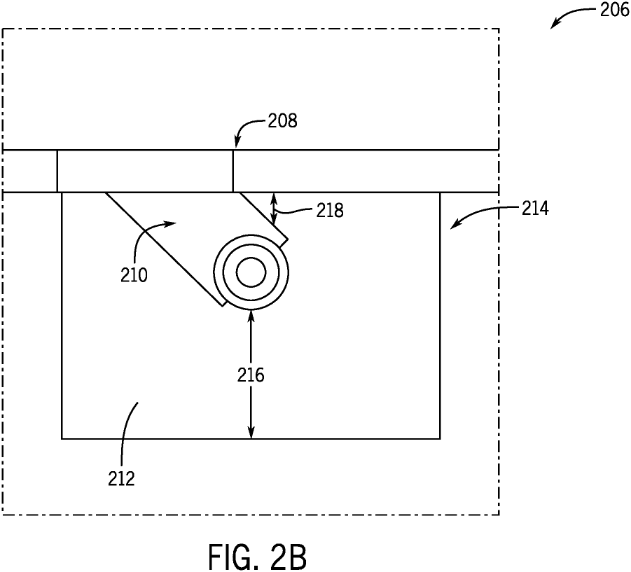

FIG. 2A is a graphical representation 200 of a dose field 202 around a tool 204. In this example, variations in the dose field 202 are clearly visible, which may be due, at least in part, to configurations of the tool body and the presence of one or more openings associated with a collimator. In this example, the dose field 202 is significantly greater near the area associated with a collimator opening, as shown in FIG. 2B, which is a schematic representation of a tool structure 206. In this example, it is shown that an opening 208 associated with the collimator 210 tracks with the higher dosage of the dose field 202 in an upward and left direction (relative to a plane of the page. That is, emitted energy will be greater through the opening 208 due to the lack of shielding material when compared to other areas of the collimator 201.

FIG. 2B illustrates a shielding material 212 forming at least a portion of a body 214 of the collimator 210. In various embodiments, the shielding material is any high density, high atomic number material, including but not limited to Tungsten. It should be appreciated that a variety of materials or mixtures of materials may be selected for shielding purposes. When the source is a gamma ray source, high density materials may be selected in order to provide greater attenuation. However, when the source is a neutron source, materials with high neutron capture cross-sections may be used. In contrast, the opening 208 is filled with a different material to allow for passage of gamma rays, such as PEEK. Due to the configuration of the tool, different thicknesses of shielding material 212 are provided at different locations of the tool 204. For example, a first thickness 216 is greater than a second thickness 218. Because of this configuration a thicker section of material leads to lower dose field 202 and a thinner section of material leads to a higher dose field 202, as shown in FIG. 2A. Embodiments of the present disclosure may overcome both drawbacks associated with no only collimator position but also shielding thickness.

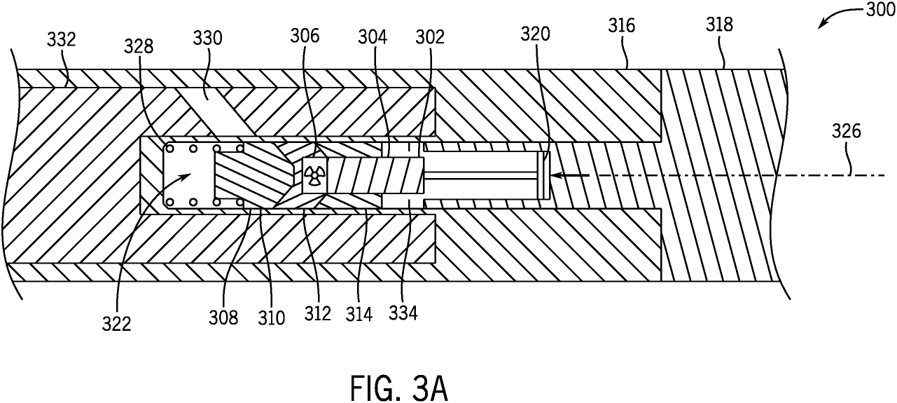

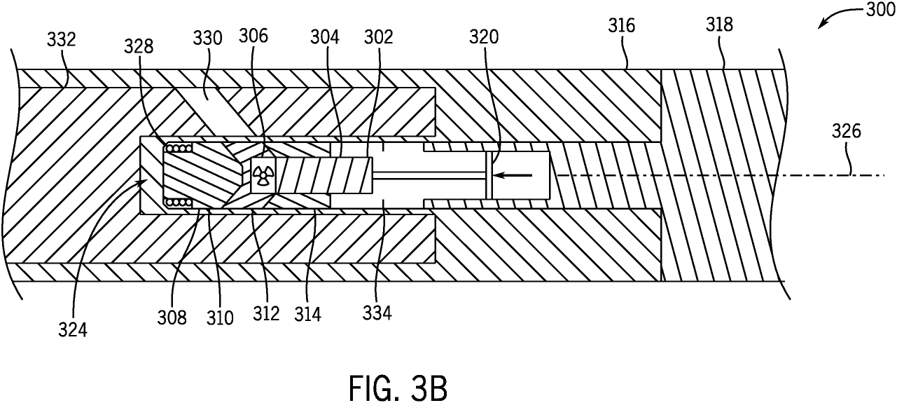

FIGS. 3A and 3B are schematic cross-sectional views of an embodiment of a tool 300 that may be utilized with embodiments of the present disclosure. In this example, FIG. 3A illustrates the tool associated with a first position and FIG. 3B illustrates the tool associated with a second position. The tool 300 includes a source package 302, which includes both source package shielding material 304 and active material 306. In at least one embodiment, the active material 306 may also be referred to as a source. The active material 306 may be a gamma ray source in one or more embodiments, such embodiments of the present disclosure are not limited to only gamma ray sources. For example, as noted, the source may include a neutron source, an x-ray source, or any other reasonable source.

Further illustrated is a source receptacle 308 that includes first source receptacle shielding material 310, source receptacle low density attenuating material 312, and second source receptacle shielding material 314. It should be appreciated that the source receptacle 308 may be formed from this group of components, which may be integrally formed or may be joined together by one or more couplers. In at least one embodiment, the source receptacle shielding material 312, 314 along with the source package shielding material 306, may be formed by a higher density, high atomic number material, including but not limited to Tungsten. It should be appreciated that a variety of other materials may be utilized, such as, by way of example, lead, copper stainless steel, any other high-Z materials, or combinations thereof. In contrast, the low density attenuating material 312 may be formed from a lower density, low atomic number material, such as but not limited to PEEK, titanium, aluminum, or combinations thereof.

In at least one embodiment, the source package 302 is coupled to the receptacle package 308 such that movement of the source package 302 also drives movement of the receptacle package 308. For example, one or more threads may be formed along the source package shielding material 304 and the source receptacle shielding material 314 to couple the components together. Such a configuration would enable different active materials 312 to be utilized for different operations based on different aspects or properties of the formation and operating conditions.

A sonde housing 316 is shown to form at least a portion of the tool 300 and includes an opening to receive a lower sub 318. The lower sub may include an actuator 320 that is configured to couple to the source package 302. It should be appreciated that the actuator 320 may not be a portion of the lower sub 318 and may be part of the housing 316, part of the source package 302, or may be a separate component, among other options. In at least one embodiment, the actuator 320 may also be referred to as a mover such that the source package 302 may be transitioned from a first position 322, shown in FIG. 3A to a second position 324, shown in FIG. 3B. In this example, the actuator 320 is a linear actuator that drives linear movement along an axis 326 of the sonde housing 316. While embodiments may be described and shown with respect to the linear actuator, various embodiments of the present disclosure may also incorporate different types of movers to transition the source package 302 between the first position 322 and the second position 324. By way of example, the mover may rotate or otherwise move the source package 304 from a location behind a shield to a location in front of a shield. In other example, the mover may activate or otherwise engage the source to beginning emission, such as by turning on a switch or causing different components to mix, among various other options.

In this example, a spring 328 or other biasing member is arranged to engage the source receptacle 308. For example, the illustrated spring 328 engages a portion of the source receptacle shielding material 304 to bias the source receptacle shielding material 310 in the first position 322 to block an aperture 330 formed in a rotating shield 332 from the active material 306. As noted above, the shield 332 may rotate about the axis 326 to provide an azimuthal analysis of the wellbore. The actuator 320 provides a force that overcomes the bias force of the spring 328 to drive the source receptacle shielding material 310 along the axis 306, out of alignment with the aperture 330, and to position the active material 306 into alignment with the aperture 330. Due to the low density of the low density attenuating material 312, a gamma ray beam may be directed toward the formation, thereby enabling interrogation of the formation and data collection. In at least one embodiment, a retaining ring 334 is positioned to facilitate locating of the source receptacle shielding material 310 to block the aperture 330.

In various embodiments, the actuator 320 may be an electric actuator, a mechanical actuator, a hydraulic actuator, a pneumatic actuator, or any reasonable type of actuator. Furthermore, the actuator 320 may be a linear actuator or may include a rotatory-to-linear conversion device or gear to convert rotatory force to a linear force. In at least one embodiment, the actuator 320 may include one or more sensors to provide position indication to an operator. For example, a sensor may be used to transmit a signal to alert the operator that the source is in a first position or a second position. Furthermore, various embodiments may include fail safe or emergency circuitry and/or mechanical devices to transition the source package 302 to the first position in the event of a failure, such as a loss of power, loss of containment within the wellbore, or the like. For example, in at least one embodiment, the actuator 320 is a solenoid that may be referred to as a normally closed solenoid such that, in a normal non-energized position, the source package 302 is in the first position 322 to block emission through the aperture 330. In another embodiment, the actuator 320 may be a fluid actuator that has a drain or the like such that pressure is released from the actuator 320 to permit the spring 328 to drive the source package 302 to the first position 322.

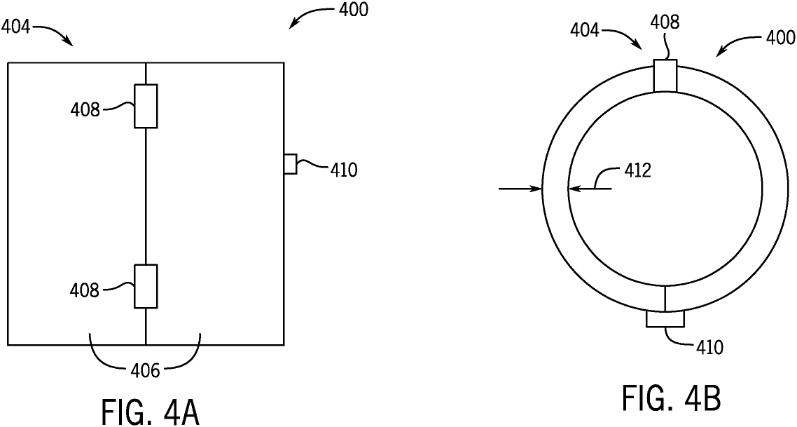

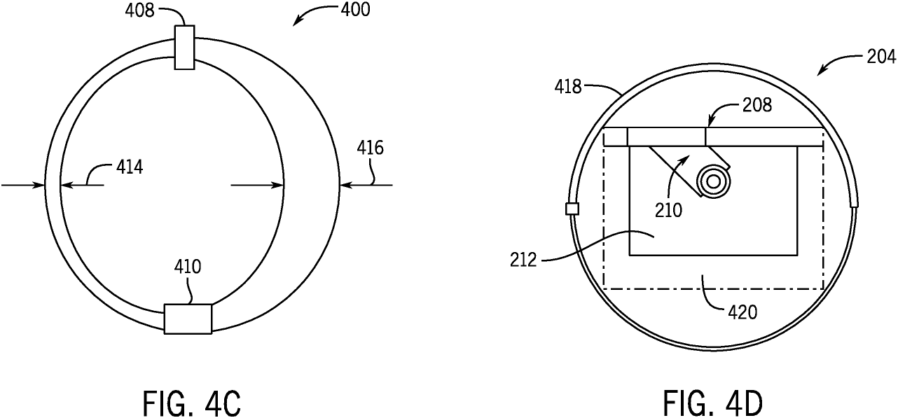

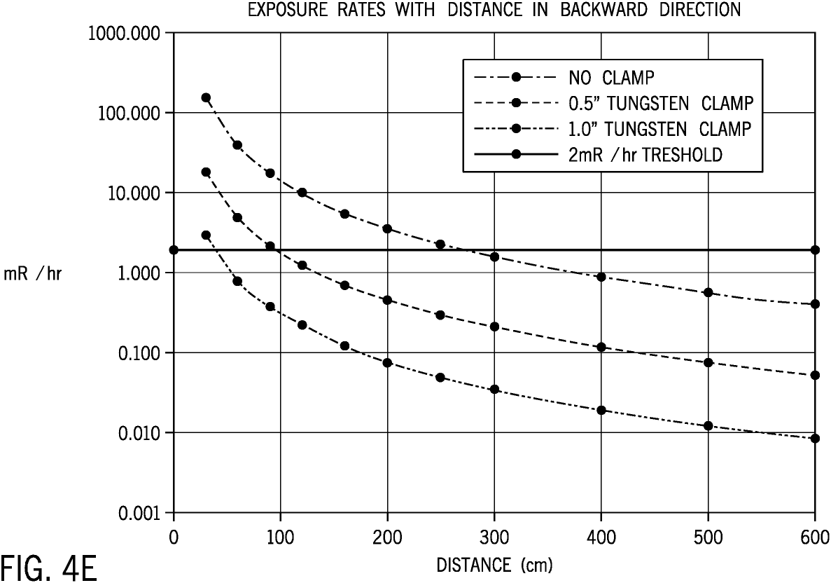

FIGS. 4A-4C are representations of a shield 400 shown in an open position 402 and a closed position 404. In this example, the shield 400 includes two panels 406, which may be curved (as shown in FIG. 4B), that are coupled together via one or more hinges 408. The hinges 408 may enable opening and closure of the shield 400 such that the shield 400 may be positioned around one or more tools, such as the tool 300. In this example, the shield 400 includes clamps 410 to secure the panels 406 together. It should be appreciated that the example of two panels 406 is for illustrative purposes only and there may be any reasonable number of panels 406 utilized. Furthermore, there may be a greater number of panels 406 with more hinges 408 that such that the panels 406 may not be curved, but may be substantially flat. In operation, the shield 400 may be positioned about one or more tools and may be supported or held in place using one or more locating features, such as a smaller diameter inner portion or a connection to the top of bottom, that holds the shield 400 into position. The clamps 410 may then be used to secure the panels 406 together and surround the tool. A thickness 412 of the panels 406 may be particularly selected such that exposure rates within a determined distance are below a threshold. For example, as shown in FIG. 4E, different dimensions for Tungsten shields are shown with respect to an exposure threshold. Accordingly, sizes may be particularly selected based on the threshold and a desired exposure at a certain distance.

FIG. 4C illustrates an embodiment where the thickness 412 is variable at different locations, which may be based, at least in part, on an expected dose field. As shown, a first area thickness 414 is smaller than a second area thickness 416. The second area thickness 416 may be selected based, at least in part, on the shielding configuration of an associated tool and/or lubricator. By making the thickness a variable thickness, weight and cost for the shield may be reduced.

FIG. 4D illustrates a schematic representation of the shield 400 associated with the tool 204 of FIG. 2. As shown in this example, the shield 400 includes a variable thickness 412 such that an area 418 near the opening 208 is larger than an area 420 on an rear side of the body 214 that has a larger material thickness to effectively act as a shield. Accordingly, weight and size of the shield 400 is reduced, thereby providing easier installation and movement at the wellsite.

Various embodiments of the present disclosure may include one or more methods for utilizing the systems described herein. By way of example, a source may be positioned within a housing and placed in a first position, where the first position is not aligned with an aperture formed in a shield. In at least one embodiment, the housing may be surrounded by one or more removable shields, but it should be appreciated that the removable shield may also be omitted. The housing may be lowered into a wellbore, where lowering the housing into the wellbore may drive movement of the removable shield along an axis, in embodiments where the shield is used. At a predetermined time, such as when the housing is a distance away from personnel or below a surface, an actuator may drive a source into a second position to align with an aperture formed in a shield. Downhole operations may commence. Prior to returning the housing to a surface location, the actuator may move the source back to the first position. In this manner, exposure or potential exposures may be reduced.

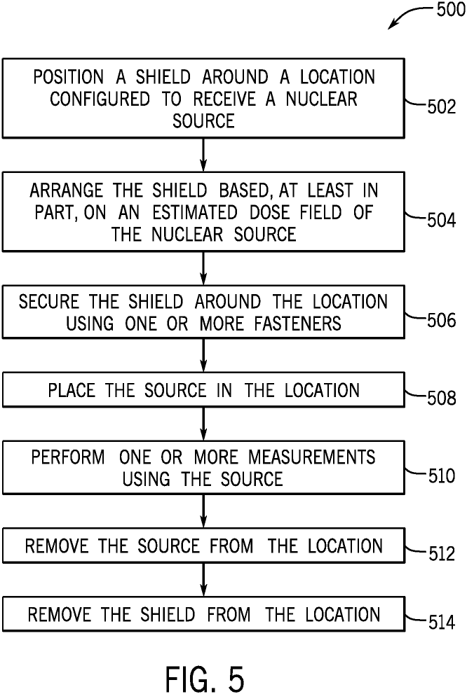

FIG. 5 is a flow chart of an embodiment of a method 500 for obtaining a measurement using a nuclear source. For this method, and all methods described herein, it should be appreciate that there may be more or fewer steps. Furthermore, the steps may be performed in any order, or in parallel, unless otherwise specifically stated. In this example, a shield is positioned around a location configured to receive a nuclear source 502. The location may be associated with a tool body or a lubricator or other uphole position to receive a tool. In at least one embodiment, the location is a fixed location that includes one or more components to receive and support the shield. In various embodiments, the shield and the location are movable, such as embodiments where the location is a tool housing.

The shield may be arranged along the location based, at least in part, on an estimated dose field 504. For example, in embodiments where the shield has variable thicknesses, the shield may be turned or otherwise positioned so that thicker portions are aligned with areas that have higher expected dose fields. The shield may be secured around the location 506, for example, by using one or more fasteners. In various embodiments, the source may be transmitted to the location 508. For example, in embodiments where the location is the lubricator, the shield may be positioned around the lubricator and then the source may be brought to the lubricator.

The source may be associated with one or more tools used to perform measurements 510 and then the source may be removed from the location 512. Thereafter, the shield may also be removed from the location 514. In this manner, the shield may be installed and removed as needed and configured for particular wellbore operations.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A downhole logging system, comprising:
a gamma ray source positioned within a logging tool, the gamma ray source to emit radiation into an area surrounding the logging tool;
a collimator associated with the gamma ray source, the collimator having an opening to direct a flow of radiation into the formation to permit gamma ray scanning of the formation;
a radiation detector operable to detect backscatter radiation from the area;
a motor to rotate the collimator in either a continuous or stepping fashion for scanning a borehole; and
an actuator associated with the gamma ray source, the actuator moving the gamma ray source between a first position and a second position, the first position being misaligned with the opening and the second position being aligned with the opening.

2. The downhole logging system of claim 1, wherein the gamma ray source forms at least a portion of a source package, the source package comprising:
source package shielding material.

3. The downhole logging system of claim 2, wherein the source package shielding material is coupled to the actuator.

4. The downhole logging system of claim 2, further comprising:
a source receptacle to receive the gamma ray source, the source receptacle being coupled to the source package shielding material.

5. The downhole logging system of claim 4, wherein the source receptacle comprises:
a first shielding material to move between the first position, covering the opening, and the second position, misaligned with the opening;
a low density attenuating material, surrounding at least a portion of the gamma ray source; and
a second shielding material configured to couple to the source package shielding material.

6. The downhole logging system of claim 1, wherein the actuator is a linear actuator.

7. The downhole logging system of claim 1, further comprising:
a removable shield associated with the logging tool, the removable shield having a thickness based, at least in part, on a threshold exposure rate at a given distance.

8. The downhole logging system of claim 7, wherein the removable shield further comprises:
at least two panels, the at least two panels being movable relative to one another;
at least one hinge for joining the at least two panels together; and
at least one clamp for securing the at least two panels together at respective opposite ends from the at least one hinge.

9. A downhole logging tool, comprising:
a housing, the housing having an aperture to permit emission of radioactive materials from the housing;
a source package, comprising:
a gamma ray source;
a source package shielding material;
a source receptacle, comprising:
a first shielding material, the first shielding material being movable from a first position blocking the aperture and a second position misaligned with the aperture; and
a low density attenuating material, positioned to at least partially surround the gamma ray source, the low density attenuating material being movable from a first position misaligned with the aperture and a second position aligned with the aperture; and
an actuator, the actuator coupled to the source package, wherein the actuator applies a force to the source package to drive movement between the first position to the second position.

10. The downhole logging tool of claim 9, further comprising:
a biasing member arranged between the housing and the first shielding material, the biasing member driving the first shielding material in a direction opposite an output of the actuator.

11. The downhole logging tool of claim 9, further comprising:
a second shielding material configured to couple to the source package shielding material.

12. The downhole logging tool of claim 9, wherein the aperture is formed in a rotatable shield.

13. The downhole logging tool of claim 9, wherein the actuator is a normally closed solenoid actuator.

14. The downhole logging tool of claim 9, wherein the first shielding material is a high density material.

15. The downhole logging tool of claim 9, wherein the low density attenuating material is at least one of PEEK, titanium, or aluminum.

16. The downhole logging tool of claim 9, further comprising:
a removable shield configured to couple to the housing, the removable shield having a variable shield thickness.

17. A method, comprising:
providing a downhole logging tool having a source in a first position, the first position arranging the source out of alignment with an aperture;
positioning the downhole logging tool within a wellbore;
causing the source to move to a second position, different from the first position, the second position arranging the source in alignment with the aperture;
performing one or more logging operations;
causing the source to move back to the first position; and
retrieving the downhole logging tool from the wellbore.

18. The method of claim 17, further comprising:
positioning a removable shield to at least partially surround a portion of the downhole logging tool; and
securing the removable shield to the logging tool.

19. The method of claim 17, further comprising:
positioning a removable shield to at least partially surround a portion of a surface well component that receives the downhole logging tool; and
securing the removable shield to the surface well component.

20. The method of claim 19, wherein the surface well component is a lubricator.
